(19) United States
(12) Patent Application Publication
(10) Pub. No.: US 2022/0260603 A1
(43) Pub. Date: Aug. 18, 2022

(54) AN ASPIRATE-DISPENSE APPARATUS AND ASSOCIATED METHODS

(71) Applicant: DOUGLAS SCIENTIFIC, LLC, Alexandria, MN (US)

(72) Inventors: Nathan Luther Westad, Parkers Prairie, MN (US); Andrew Richard Haug, Alexandria, MN (US)

(21) Appl. No.: 17/630,471

(22) PCT Filed: Jul. 23, 2020
(86) PCT No.: PCT/GB2020/051769

§ 371 Date: Jan. 26, 2022

Related U.S. Application Data
(60) Provisional application No. 62/882,034, filed on Aug. 2, 2019.

(51) Int. Cl. G01N 35/10; B01L 3/02; G01N 35/00

(52) U.S. Cl. CPC G01N 35/1016; B01L 3/0237; B01L 2400/06; G01N 35/1072; B01L 2200/0605; G01N 35/00693

(57) ABSTRACT

A controller configured to control one or more of aspiration and dispensing of a primary fluid by an aspirate-dispense apparatus, the aspirate-dispense apparatus comprising a secondary fluid in working communication with the primary fluid, wherein the controller is configured to: receive measurement signalling for a monitored flow parameter of the secondary fluid; determine, using calibration data, a volume of aspirated or dispensed primary fluid based on the received measurement signalling, the calibration data defining a relationship between the volume of aspirated or dispensed primary fluid and the monitored flow parameter of the secondary fluid; and control the flow of primary or secondary fluid based on the determined volume to aspirate or dispense a specific volume of primary fluid.

### TECHNICAL FIELD

The present disclosure relates to the aspiration and dispensing of fluids and concerns an apparatus and associated methods for controlling the same.

### BACKGROUND

Existing aspiration-dispense systems rely on time to monitor and control the aspirated or dispensed volume of fluid. Since flow rate varies with pressure, physical characteristics of the conduits, and fluid viscosity (amongst other factors), however, this approach is inaccurate and can result in wasted fluid.

The apparatus and methods disclosed herein may help to address this issue.

### SUMMARY

According to a first aspect, there is provided a controller configured to control one or more of aspiration and dispensing of a primary fluid by an aspirate-dispense apparatus, the aspirate-dispense apparatus comprising a secondary fluid in working communication with the primary fluid, wherein the controller is configured to:
receive measurement signalling for a monitored flow parameter of the secondary fluid;
determine, using calibration data, a volume of aspirated or dispensed primary fluid based on the received measurement signalling, the calibration data defining a relationship between the volume of aspirated or dispensed primary fluid and the monitored flow parameter of the secondary fluid; and
control the flow of primary or secondary fluid based on the determined volume to aspirate or dispense a specific volume of primary fluid.

The aspirate-dispense apparatus may be configured to aspirate or dispense volumes of primary fluid in the millilitre volume range or below.

The monitored flow parameter of the secondary fluid may comprise a displaced volume of secondary fluid, and the controller may be configured to:
determine when the specific volume of primary fluid has been aspirated or dispensed based on the displaced volume of secondary fluid reaching a first predefined threshold; and
terminate the flow of primary or secondary fluid based on said determination.

The controller may be configured to:
determine a sudden change in the monitored flow parameter of the secondary fluid, or a measurement of the monitored flow parameter which is above or below a second predefined threshold, based on the received measurement signalling; and
terminate the flow of primary or secondary fluid based on said determination.

The controller may be configured to generate a notification indicative of the detected sudden change or measurement above/below the second predefined threshold.

The aspirate-dispense apparatus may comprise a flow meter configured to measure the monitored flow parameter of the secondary fluid, a pressure regulator configured to regulate the pressure of the secondary fluid, and a valve configured to limit the flow of primary or secondary fluid, and the controller may be configured to:
receive the measurement signalling for the monitored flow parameter of the secondary fluid from the flow meter to enable determination of the volume of aspirated or dispensed primary fluid; and
control the pressure regulator and valve based on the determined volume of aspirated or dispensed primary fluid to control the flow of primary or secondary fluid.

The controller may be configured to generate the calibration data defining the relationship between the volume of aspirated or dispensed primary fluid and the monitored flow parameter of the secondary fluid.

The controller may be configured to generate the calibration data by:
controlling the pressure regulator and valve to aspirate or dispense one or more known volumes of primary fluid;
receiving, from the flow meter, respective measurements of the monitored flow parameter of the secondary fluid corresponding to the one or more known volumes of primary fluid; and
associating the one or more known volumes of primary fluid with the respective measurements of the monitored flow parameter of the secondary fluid.

The controller may be configured to associate the plurality of known volumes of primary fluid with the plurality of respective measurements of the monitored flow parameter of the secondary fluid by generating one or more of a look-up table, a graph and an equation defining the relationship therebetween.

The controller may be further configured to control the flow of primary or secondary fluid to dispense the specific volume of primary fluid by:
controlling the pressure regulator and valve to aspirate a known volume of primary fluid;
controlling the pressure regulator and valve to incrementally dispense the aspirated primary fluid over a recorded number of dispense cycles; and
determining a cycle volume based on the known volume of primary fluid and recorded number of dispense cycles.

Each dispense cycle may have a known duration, and the controller may be further configured to:
determine a dispense duration required to dispense the specific volume of primary fluid based on the cycle duration and cycle volume; and
control the pressure regulator and valve to dispense the primary fluid for the determined dispense duration.

The controller may be further configured to:
calculate a cycle volume for a plurality of different cycle durations; and
associate the cycle volume with each cycle duration to generate further calibration data.

The controller may be configured to associate the cycle volume with each cycle duration by generating one or more of a look-up table, a graph and an equation defining the relationship therebetween.

The controller may be further configured to:
determine, using the further calibration data, the cycle duration required to dispense the specific volume of primary fluid; and
control the pressure regulator and valve to dispense the primary fluid for the determined cycle duration.

According to a further aspect, there is provided an aspirate-dispense apparatus comprising any controller described herein.

The aspirate-dispense apparatus may further comprise flow meter circuitry configured to convert an output signal from the flow meter to the received measurement signalling, and valve circuitry configured to interface the valve with the controller.

The aspirate-dispense apparatus may comprise a plurality of primary fluid channels through which the primary fluid can flow into or out of the aspirate-dispense apparatus, and a plurality of corresponding secondary fluid channels connected to the respective primary fluid channels to provide the working communication between the primary and secondary fluids.

Each primary or secondary fluid channel may comprise a filter configured to prevent the primary fluid from contacting the flow meter.

The plurality of primary fluid channels may be connected to a common primary manifold configured to receive and contain the primary fluid aspirated via the plurality of primary fluid channels.

Each primary fluid channel may comprise a tip configured to receive and contain the primary fluid aspirated via the respective primary fluid channel.

The tip may be a pipette tip for one or more of aspiration (e.g. aspiration tip) and dispensing (e.g. dispensing tip). The tip may be configured for single use (i.e. disposable tip) or multiple use (i.e. reusable tip). Disposable tips may be used to reduce contamination between different samples of primary fluid.

The primary manifold or tip may have a capacity which is sufficient to contain a volume of primary fluid required for multiple dispense cycles.

The plurality of secondary fluid channels may be connected to a common secondary manifold configured to interface the plurality of secondary fluid channels with the pressure regulator.

The primary fluid may be a liquid and the secondary fluid may be a gas.

According to a further aspect, there is provided a method of controlling one or more of aspiration and dispensing of a primary fluid by an aspirate-dispense apparatus, the aspirate-dispense apparatus comprising a secondary fluid in working communication with the primary fluid, wherein the method comprises:
receiving measurement signalling for a monitored flow parameter of the secondary fluid;
determining, using calibration data, a volume of aspirated or dispensed primary fluid based on the received measurement signalling, the calibration data defining a relationship between the volume of aspirated or dispensed primary fluid and the monitored flow parameter of the secondary fluid; and
controlling the flow of primary or secondary fluid based on the determined volume to aspirate or dispense a specific volume of primary fluid.

According to a further aspect, there is provided an aspirate-dispense apparatus as substantially described herein with reference to, and as illustrated by, the accompanying drawings.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying schematic drawings, in which:—

FIG. 1 shows schematically an aspirate-dispense apparatus comprising a head assembly and a control assembly;

FIG. 2 shows graphically calibration data for a dispensing operation of the aspirate-dispense apparatus;

FIG. 3a shows in front view the head assembly;

FIG. 3b shows in cross-section the head assembly;

FIG. 4 shows schematically a flow meter subassembly of the control assembly;

FIG. 5a shows in front view a non-contact valve-tip subassembly;

FIG. 5b shows in front view a contact valve-tip subassembly;

FIG. 5c shows in exploded view the contact valve-tip subassembly;

FIG. 5d shows in cross-section the contact valve-tip subassembly;

FIG. 6 shows in the form of a flow chart a method of controlling the aspirate-dispense apparatus; and

FIG. 7 shows schematically a computer-readable medium comprising a computer program configured to control, perform or enable the method of FIG. 6.

### DESCRIPTION OF SPECIFIC ASPECTS/EMBODIMENTS

As mentioned previously, the present disclosure relates to an apparatus and associated methods for controlling the aspiration and/or dispensing of fluids. In particular, but not exclusively, the apparatus and associated methods may be configured to control the aspiration and/or dispensing of fluid in the millilitre volume range or below (e.g. microfluidics). This may be applied to industries such as life sciences, healthcare, agri-food technology and the environment.

Later described embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

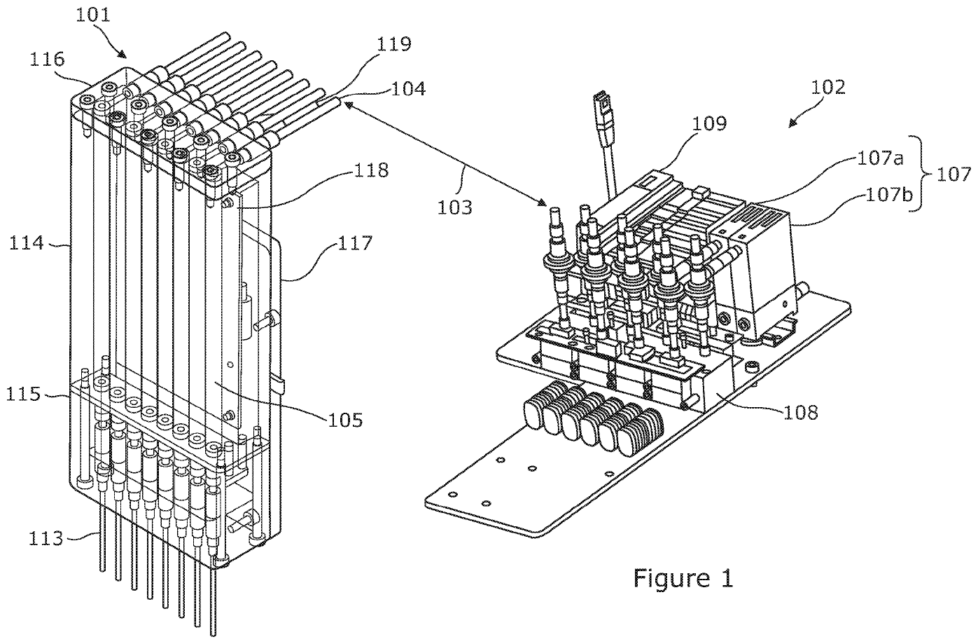

FIG. 1 shows schematically an aspirate-dispense apparatus comprising a head assembly 101 and a control assembly 102 which, in use, are in fluid communication 103 with one another via one or more fluid connectors 104. The head assembly 101 is configured to aspirate and/or dispense a primary fluid under the control of the control assembly 102. To enable this control, the aspirate-dispense apparatus comprises a secondary fluid in working communication with the primary fluid. The expression “working communication” in this context may be taken to mean that the secondary fluid is in direct or indirect (e.g. via an intermediary component such as a piston) contact with the primary fluid such that a flow of the secondary fluid causes a corresponding flow of the primary fluid and vice-versa.

In some examples, the aspirate-dispense apparatus may comprise a single primary fluid channel 105 through which the primary fluid can flow into or out of the aspirate-dispense apparatus, and a single secondary fluid channel 406 connectable to the primary fluid channel 105 to provide the working communication between the primary and secondary fluids. In other examples, however, the aspirate-dispense apparatus may comprise a plurality of primary fluid channels 105 and a plurality of corresponding secondary fluid channels 406. The latter scenario may be useful when the aspirate-dispense apparatus is being used to aspirate from, or dispense to, a plurality of fluid containers such as a multi-well plate or tape for processing multiple samples in parallel.

The control assembly 102 itself comprises a pressure regulator 107, a flow meter subassembly 108 and a controller 109. The pressure regulator 107 is configured to regulate the pressure of the secondary fluid to cause a flow thereof. In this example, the pressure regulator 107 is divided into two different parts: an aspirate pressure regulator 107a which provides a negative pressure (or vacuum) to the flow meter subassembly 108 for use in aspirating the primary fluid; and a dispense pressure regulator 107b which provides a positive pressure to the flow meter subassembly 108 for use in dispensing the primary fluid. In other examples, the aspirate 107a and dispense 107b pressure regulators could be replaced by a single pressure regulator configured to provide both the positive and negative pressures. As described in more detail below, the flow meter subassembly 108 comprises a flow meter 410 configured to monitor a flow parameter of the secondary fluid.

The controller 109 is configured to control one or more of aspiration and dispensing of the primary fluid by the head assembly 101. To achieve this, the controller 109 receives measurement signalling for the monitored flow parameter of the secondary fluid from the flow meter 410. The controller 109 then determines, using calibration data defining a relationship between the volume of aspirated or dispensed primary fluid and the monitored flow parameter of the secondary fluid, a volume of aspirated or dispensed primary fluid using the received measurement signalling (i.e. the controller 109 monitors the aspirated/dispensed volume substantially in real-time). Based on this determined/monitored volume, the controller 109 controls the flow of primary or secondary fluid in order to aspirate or dispense a specific volume of primary fluid. The flow of primary or secondary fluid may be controlled by controlling the pressure regulator 107 and/or a valve 511 configured to limit the flow of primary or secondary fluid. The valve 511 can be located either within the head assembly 101 (i.e. for limiting the flow of primary fluid) or the control assembly 102 (i.e. for limiting the flow of secondary fluid).

The controller 109 may comprise a processor and a memory storing computer program code, the memory and computer program code configured to, with the processor, cause the controller 109 to perform the described functionality. The processor may be configured for general operation of the aspirate-dispense apparatus by providing signalling to, and receiving signalling from, the other components to manage their operation. The memory may be configured to store computer code configured to perform, control or enable operation of the aspirate-dispense apparatus. The memory may also be configured to store settings for the other components. The processor may access the memory to retrieve the component settings in order to manage the operation of the other components. The processor may be a microprocessor, including an Application Specific Integrated Circuit (ASIC). The memory may be a temporary storage medium such as a volatile random access memory. On the other hand, the storage medium may be a permanent storage medium such as a hard disk drive, a flash memory, or a non-volatile random access memory. Additionally or alternatively, the controller 109 may comprise suitable logic circuitry configured to perform the described functionality.

The monitored flow parameter of the secondary fluid may include a displaced volume of secondary fluid. In this scenario, the controller 109 is configured to determine when the specific volume of primary fluid has been aspirated or dispensed based on the displaced volume of secondary fluid reaching a first predefined threshold, and terminate the flow of primary or secondary fluid based on said determination. The monitored flow parameter is not limited to the displaced volume of secondary fluid, however. Other suitable examples include pressure and flow rate of the secondary fluid (or a combination of two or more of these parameters).

Unlike existing systems, therefore, the volume of aspirated or dispensed primary fluid is determined and controlled based on the monitored flow parameter of the secondary fluid rather than relying exclusively on time. In this way, the aspirated or dispensed volume is less dependent upon the variable characteristics of the apparatus or primary fluid resulting in greater accuracy and less waste. The present approach also facilitates automation of the aspiration or dispense operation thereby reducing human error and calibration time.

As well as determining and controlling the volume of aspirated or dispensed primary fluid, the monitoring of a flow parameter of the secondary fluid also has other uses. For instance, there may be a sudden change in the monitored flow parameter once all the primary fluid (excluding dead volume for aspiration) has been aspirated or dispensed. This is because there is typically a difference in the flow characteristics, and therefore displacement, of different fluids. This is particularly dramatic when there is a change in state from liquid to gas (or vice-versa) and can be used to indicate run-out of the primary fluid from the source container or the head assembly 101. In this scenario, the controller 109 may be configured to terminate the flow of primary or secondary fluid based on determination of the sudden change in the monitored flow parameter of the secondary fluid to discontinue the aspiration or dispensing operation. The controller 109 may also be configured to generate a notification indicative of the detected sudden change for the benefit of a user of the aspirate-dispense apparatus.

There may also be a detectable change in the monitored flow parameter with wear and tear, or failure, of a component of the aspirate-dispense apparatus. This can occur, for example, due to a change in pressure caused by a leak in the system. Here, the controller 109 may be configured to terminate the flow of primary or secondary fluid if a measurement of the flow parameter is above or below a second predefined threshold to enable inspection and repair/replacement of the relevant component. Similar to a detected sudden change in the monitored flow parameter, the controller 109 may also be configured to generate a notification indicative of the monitored flow parameter being above or below the second predefined threshold to alert a user about the possible need for maintenance of the aspirate-dispense apparatus.

Whilst the primary fluid would typically be a liquid and the secondary fluid would typically be a gas, the aspirate-dispense apparatus is not limited in this way. For instance, both the primary and secondary fluids could be liquids provided that the secondary fluid does not intermix with, or cause a chemical or biological change in, the primary fluid. In this respect, the primary fluid could be water and the secondary fluid could be a hydrophobic liquid such as an oil (or vice-versa). Furthermore, when the primary fluid is a liquid and the secondary fluid is a gas, the gas should be sufficiently inert and insoluble in the primary fluid that it does not cause a chemical or biological change in the primary fluid, or a change in pressure that could potentially affect the calibration. Ideally, the primary and secondary fluids would also exhibit sufficiently distinct flow parameters that run-out of the primary fluid during a dispensing operation can be detected based on a sudden change in the flow parameter. Examples of primary fluids include biological or nucleic acid samples (such as human, plant or animal biological materials or genetic samples), chemistries and reagents (such as nucleic acid sample preparation reagents, molecular biology reagents and polymerase chain reaction reagents). For instance, the aspirate-dispense apparatus may be used for aspirating and/or dispensing saliva samples being tested for diseases such as COVID-19. Field-collected saliva samples can vary in viscosity and consistency, but the present apparatus is well-suited to such primary fluids because it does not rely on time to monitor and control the aspirated or dispensed volume. The aspirate-dispense apparatus may also be used with primary fluids such as oligo synthesis reagents and genome sequencing samples and reagents for the production of oligonucleotides. Examples of secondary fluids include air, helium, nitrogen and argon.

As mentioned above, the controller 109 uses calibration data in order to determine/monitor the volume of aspirated or dispensed primary fluid. The calibration data defines the relationship between the volume of aspirated or dispensed primary fluid and the flow parameter of the secondary fluid. This may be generated by the controller 109 for each type of primary fluid. To generate the calibration data, the controller 109 may be configured to control the pressure regulator 107 and/or valve 511 to aspirate or dispense one or more known volumes of primary fluid, and receive (from the flow meter 410) respective measurements of the flow parameter of the secondary fluid corresponding to the one or more known volumes of primary fluid. The controller 109 may then associate the one or more known volumes of primary fluid with the respective measurements of the flow parameter of the secondary fluid for use in subsequent aspiration or dispense operations, e.g. by generating one or more of a look-up table, a graph and an equation defining the relationship therebetween.

In practice, however, the aspiration and dispensing operations may be calibrated separately. This is because aspiration of the primary fluid using the aspirate-dispense apparatus is independent of fluid viscosity whereas dispensing of the primary fluid may not be. Regarding aspiration, the controller 109 may begin the calibration process by controlling the pressure regulator 107 and valve 511 to aspirate primary fluid from a source container containing an unknown volume of primary fluid until a sudden change in the monitored flow parameter of the secondary fluid is detected. This sudden change in the monitored flow parameter indicates that the head assembly 101 has aspirated as much of the primary fluid as it possibly can and is now aspirating air (or another environmental gas). Any primary fluid remaining in the source container is referred to as an “aspiration dead volume”. This is the volume of primary fluid that the head assembly 101 cannot aspirate from the source container due to physical restrictions such as the size and shape of the source container relative to that of the tip(s) 512 of the head assembly 101 (the latter of which are described in more detail below). The aspirated primary fluid is then dispensed as waste.

A known calibration volume V₁ of primary fluid is then added to the source container (which still contains the aspiration dead volume of primary fluid) before the controller 109 aspirates the primary fluid until a sudden change in the monitored flow parameter is detected as before. If the monitored flow parameter is the displaced volume of secondary fluid V₂, an aspiration calibration gain value G can be determined using a measurement of the displaced volume V₂ of the secondary fluid together with a knowledge of any pre-existing gain value G₀ as per the following equation:

$$G = {G}_{0} \times ( \frac{{V}_{2}}{{V}_{1}} ) \qquad$$

The displaced volume of secondary fluid V₂ measured during any subsequent aspiration operations can then be multiplied by the aspiration calibration gain value to provide a more accurate measurement of the aspirated volume of primary fluid.

Fluid viscosity affects the rate of flow of the primary fluid out of the tip(s) 512 of the head assembly and thus the length of time that the valve 511 needs to be open for in order to dispense a particular volume of primary fluid. As such, the controller 109 may be configured to generate further calibration data for dispensing operations. In this respect, the controller 109 may first control the pressure regulator 107 and valve 511 to aspirate a known volume of primary fluid. This can be achieved by using the calibration data generated for aspiration operations to terminate the aspiration operation once the known volume has been aspirated, or by aspirating all of the primary fluid in the source container minus the aspiration dead volume as before.

Once the known volume has been aspirated, the controller 109 then incrementally dispenses the aspirated primary fluid over a recorded number of dispense cycles until a sudden change in the monitored flow parameter of the secondary fluid is detected. This sudden change in the monitored flow parameter indicates that the head assembly 101 has dispensed as much of the primary fluid as it possibly can and is now aspirating air (or another secondary fluid). Any primary fluid remaining in the head assembly 101 is referred to as a “dispensing dead volume”. This is the volume of primary fluid that the head assembly 101 is unable to aspirate from the system. In practice, the controller 109 may incrementally dispense the aspirated primary fluid by periodically opening the valve 511 for a known duration (or “valve opening time”). The controller 109 then determines a cycle volume (i.e. the dispensed volume of primary fluid per dispense cycle) by dividing the known volume of primary fluid by the recorded number of dispense cycles. This data can then be used during future dispense operations to dispense a specific volume of primary fluid using a plurality of dispense cycles. In this scenario, the controller 109 determines a dispense duration required to dispense the specific volume of primary fluid by dividing the specific volume by the cycle volume, and multiplying this by the cycle duration. It then controls the pressure regulator 107 and/or valve 511 to dispense the primary fluid for the determined dispense duration. The controller 109 may be further configured to calculate a cycle volume for a plurality of different cycle durations and associate the cycle volume with cycle duration in the form of a look-up table, graph and/or equation defining the relationship therebetween.

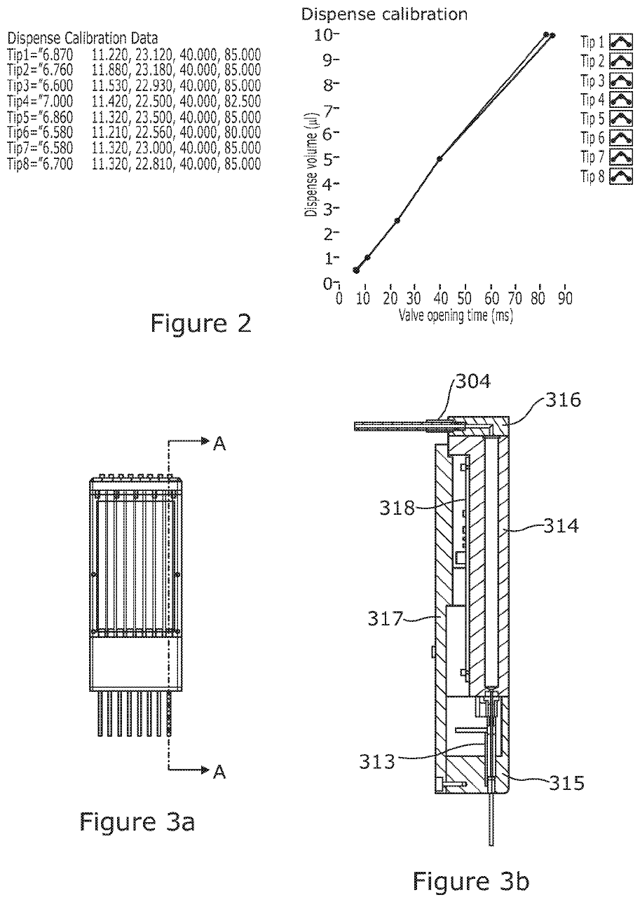

FIG. 2 shows an example of the further calibration data for an experimental dispensing operation of the aspirate-dispense apparatus. During this experiment, water and air were used as the primary and secondary fluids, respectively, and the head assembly 101 had 8 primary fluid channels 105 each comprising a tip 512 through which the primary fluid was aspirated and dispensed. For each tip 512, the cycle volume was determined for 5 different cycle durations and then plotted as a graph. As can be seen from the data, there were slight variations in the cycle duration (“valve opening time”) between tips 512, but an approximately linear relationship for each tip 512. This data can then by used during future dispense operations to dispense a specific volume of primary fluid using a single dispense cycle. In this scenario, the controller 109 determines the cycle duration required to dispense the specific volume of primary fluid by reading, interpolating or extrapolating the further calibration data. It then controls the pressure regulator 107 and/or valve 511 to dispense the primary fluid for the determined cycle duration.

As shown in FIG. 1, the head assembly 101 comprises a number of additional components that will now be described. In this example, the head assembly 101 comprises a plurality of primary fluid channels 105 (8 rather than a single primary fluid channel 105), each having a valve-tip subassembly 113 through which the primary fluid can flow into or out of the aspirate-dispense apparatus. The valve-tip subassembly 113 itself comprises a tip 512 and a valve 511 configured to limit the flow of primary fluid therethrough. The plurality of primary fluid channels 105 are connected to a common primary manifold 114 configured to receive and contain the primary fluid aspirated via the respective valve-tip subassemblies 113. In this respect, the primary manifold 114 may have a capacity which is sufficient to contain a volume of primary fluid required for multiple dispense cycles from each primary fluid channel 105.

The head assembly 101 further comprises a valve cover 115 configured to protect the valve-tip subassemblies 113 from damage, a detachable manifold cover 116 configured to facilitate cleaning of the common primary manifold 114 underneath, and a manifold mount 117 configured for mechanically fastening the head assembly 101 to another object. The latter feature may help to ensure that the primary fluid channels 105 are in a fixed orientation (e.g. substantially vertical in use) between consecutive aspiration or dispense operations for greater consistency. The head assembly 101 also comprises valve circuitry configured to interface the valve 511 of each valve-tip subassembly 113 with the controller 109 of the control assembly 102. In this example, the valve circuitry comprises a circuit board 118 and a wired connection 119 between the circuit board 118 and the controller 109, but a wireless connection could be used instead. The circuit board 118 may comprise indicator lights (or light-emitting diodes) that indicate the open or closed state of each valve 511.

FIGS. 3a and 3b show front and cross-sectional views of the head assembly 101. The cross-section in FIG. 3b has been taken through line A-A as indicated in FIG. 3a. The various components are as described above in relation to FIG. 1 and are therefore denoted by corresponding reference numerals.

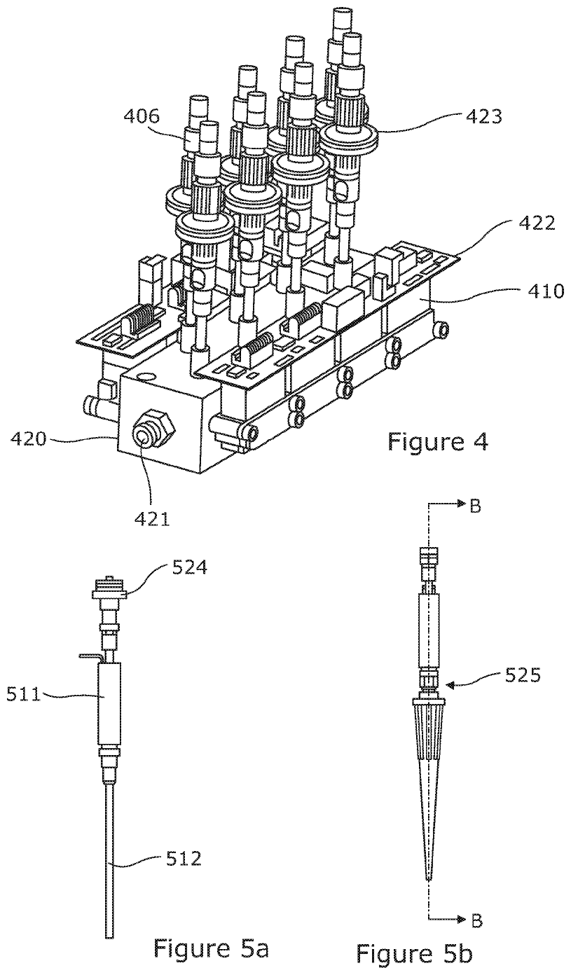

FIG. 4 shows schematically the flow meter subassembly 108 of the control assembly 102. In this example, the flow meter subassembly 108 comprises a plurality of secondary fluid channels 406 (8 rather than a single secondary fluid channel 406) which are connectable to corresponding primary fluid channels 105 of the head assembly 101 via a plurality of respective fluid connectors 104. The plurality of secondary fluid channels 406 are also connected to a common secondary manifold 420 of the flow meter subassembly 108 which is configured to interface the plurality of secondary fluid channels 406 with the pressure regulator 107 through a pressure inlet 421.

The flow meter subassembly 108 further comprises a respective flow meter 410 configured to independently monitor the flow parameter of the secondary fluid within each of the different secondary fluid channels 406, and flow meter circuitry 422 configured to convert the output signal from each flow meter 410 to measurement signalling suitable for use by the controller 109. In addition, each of the secondary fluid channels 406 comprise a filter 423 configured to prevent the primary fluid from contacting, and potentially damaging, the flow meter 410 (although they could be positioned within the primary fluid channels 105 or the fluid connectors 104 between the primary 105 and secondary 406 fluid channels instead). Whilst the flow of primary fluid into the secondary fluid channels 406 is unlikely to happen with the monitored flow parameter of the secondary fluid being used to control aspiration and dispensing of the primary fluid, the filters 423 serve as a safety feature if it does. The specific filters required will depend upon the type of primary fluid. For example, hydrophobic filters may be used when the primary fluid is water and oleophobic filters may be used when the primary fluid is an oil.

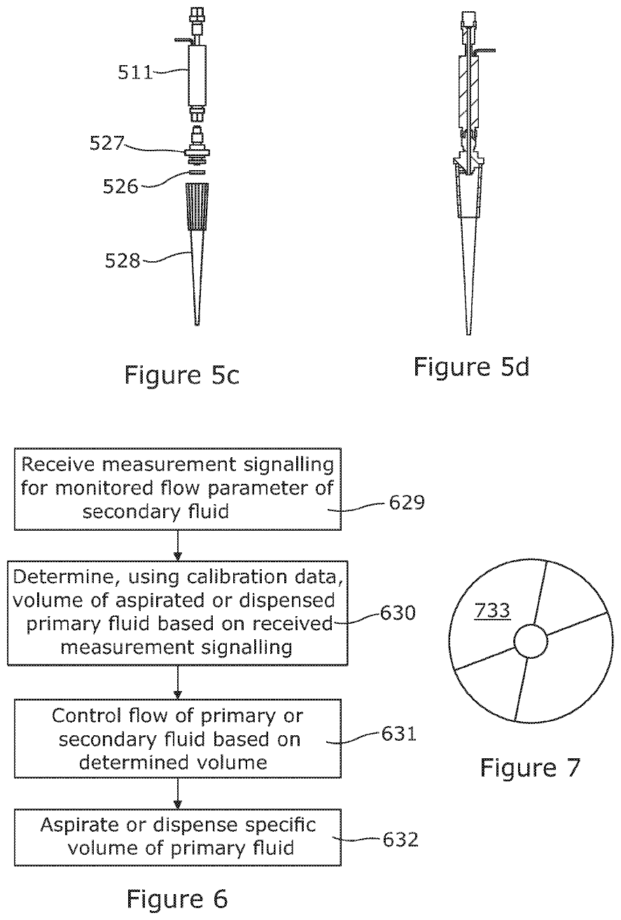

FIG. 5a shows a non-contact valve-tip subassembly 113 of the head assembly 101. As mentioned above, the primary fluid enters and leaves the head assembly 101 via the valve-tip subassembly 113. In this example, the valve-tip subassembly 113 comprises a tip 512, a valve 511 and a mandrel 524. The tip 512 provides a metered orifice which regulates the velocity of primary fluid with pressure according to Bernoulli's principle, but does not contact the fluid container into which the primary fluid is dispensed during the dispense operation (hence “non-contact”). The valve 511 limits the flow of primary fluid therethrough as instructed by the controller 109 (typically between open and closed states), whilst the mandrel 524 allows access to the tip 512 and valve 511 to facilitate maintenance or replacement thereof.

FIGS. 5b-d show front, exploded and cross-sectional views of a contact valve-tip subassembly 525, respectively. The cross-section in FIG. 5d has been taken through line B-B as indicated in FIG. 5b. The contact valve-tip subassembly 525 comprises a tip 528, an O-ring 526, a valve 511, a mandrel 524 and a valve-to-tip fitting 527. The mandrel 524 is similar to that of FIG. 5a, the valve-to-tip fitting 527 is used to connect the valve 511 to the tip 528, and the O-ring 526 seals the valve-to-tip fitting 527 to provide a fluid-tight connection. Unlike the valve-tip subassembly 113 of FIG. 5a, this tip 528 is configured to break the surface of the primary fluid in the fluid container during the dispense operation (hence “contact”). Furthermore, the tip 528 is configured to receive and contain the aspirated primary fluid and, in some cases, may have a capacity which is sufficient to contain a volume of primary fluid required for multiple dispense cycles. As such, the tip 528 of FIGS. 5b-d removes the need for a common primary manifold 114 and manifold cover 116 in the head assembly 101. To account for this change, each fluid connector 304 may be connected directly to the valve 511 of a contact valve-tip subassembly rather than the manifold cover 316 as per the head assembly 301 of FIG. 3b.

A more detailed description of the aspiration and dispensing modes of the aspirate-dispense apparatus of FIG. 1 will now be provided. In the aspiration mode, the controller 109 sends an “initiate” signal to the aspirate pressure regulator 107a and valve circuitry to open the valve 511 of the valve-tip subassembly 113 and apply a negative pressure to the pressure inlet 421 of the common secondary manifold 420. This causes a flow of secondary fluid from the primary fluid channels 105 through the fluid connectors 104 to the secondary fluid channels 406. The flow of secondary fluid causes primary fluid to be drawn through the tips 512 and into the common primary manifold 114. During this process, the flow of secondary fluid through the secondary fluid channels 406 is monitored by the respective flow meters 410, the output signals of which are converted by the flow meter circuitry 422 into suitable measurement signalling for the controller 109. The controller 109 monitors the volume of aspirated primary fluid based on the measurement signalling and calibration data, and terminates the flow of secondary fluid once the desired volume of primary fluid has been aspirated. Termination of the flow of secondary fluid is performed by sending a “terminate” signal to the aspirate pressure generator 107a and valve circuitry to close the valve 511 of the valve-tip subassembly 113 and remove the negative pressure applied to the pressure inlet 421 of the common secondary manifold 420.

In the dispensing mode, the controller 109 sends an “initiate” signal to the dispense pressure regulator 107b and valve circuitry to open the valve 511 of the valve-tip subassembly 113 and apply a positive pressure to the pressure inlet 421 of the common secondary manifold 420. This causes a flow of secondary fluid from the secondary fluid channels 406 through the fluid connectors 104 to the primary fluid channels 105. The flow of secondary fluid causes primary fluid to be dispensed out of the common primary manifold 114 and through the tips 512. The primary fluid can be dispensed in a single (longer) dispense cycle or incrementally over the course of a plurality of (shorter) dispense cycles. During this process, the flow of secondary fluid through the secondary fluid channels 406 is monitored by the respective flow meters 410, the output signals of which are converted by the flow meter circuitry 422 into suitable measurement signalling for the controller 109. The controller 109 monitors the volume of dispensed primary fluid based on the measurement signalling and calibration data, and terminates the flow of secondary fluid once the desired volume of primary fluid has been dispensed. Termination of the flow of secondary fluid is performed by sending a “terminate” signal to the dispense pressure generator 107b and valve circuitry to close the valve 511 of the valve-tip subassembly 113 and remove the positive pressure applied to the pressure inlet 421 of the common secondary manifold 420.

FIG. 6 shows the main steps 629-632 of a method of controlling one or more of aspiration and dispensing of a primary fluid by an aspirate-dispense apparatus described herein. As illustrated, the method generally comprises: receiving 629 measurement signalling for a monitored flow parameter of the secondary fluid; determining 630, using calibration data, a volume of aspirated or dispensed primary fluid based on the received measurement signalling, the calibration data defining a relationship between the volume of aspirated or dispensed primary fluid and the monitored flow parameter of the secondary fluid; controlling 631 the flow of primary or secondary fluid based on the determined volume; and aspirating or dispensing 632 a specific volume of primary fluid.

FIG. 7 illustrates schematically a computer/processor readable medium 733 providing a computer program. The computer program may comprise computer code configured to perform, control or enable one or more of the method steps 629-632 of FIG. 6. In this example, the computer/processor readable medium 733 is a disc such as a digital versatile disc (DVD) or a compact disc (CD). In other embodiments, the computer/processor readable medium 733 may be any medium 733 that has been programmed in such a way as to carry out an inventive function. The computer/processor readable medium may be a removable memory device such as a memory stick or memory card (SD, mini SD, micro SD or nano SD).

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A controller configured to control one or more of aspiration and dispensing of a primary fluid by an aspirate-dispense apparatus, the aspirate-dispense apparatus comprising a secondary fluid in working communication with the primary fluid, wherein the controller is configured to:
receive measurement signalling for a monitored flow parameter of the secondary fluid;
determine, using calibration data, a volume of aspirated or dispensed primary fluid based on the received measurement signalling, the calibration data defining a relationship between the volume of aspirated or dispensed primary fluid and the monitored flow parameter of the secondary fluid; and
control the flow of primary or secondary fluid based on the determined volume to aspirate or dispense a specific volume of primary fluid.

2. The controller of claim 1, wherein the aspirate-dispense apparatus is configured to aspirate or dispense volumes of primary fluid in the millilitre volume range or below.

3. The controller of claim 1 or 2, wherein the monitored flow parameter of the secondary fluid comprises a displaced volume of secondary fluid, and wherein the controller is configured to:
determine when the specific volume of primary fluid has been aspirated or dispensed based on the displaced volume of secondary fluid reaching a first predefined threshold; and
terminate the flow of primary or secondary fluid based on said determination.

4. The controller of any preceding claim, wherein the controller is configured to:
determine a sudden change in the monitored flow parameter of the secondary fluid, or a measurement of the monitored flow parameter which is above or below a second predefined threshold, based on the received measurement signalling; and
terminate the flow of primary or secondary fluid based on said determination.

5. The controller of claim 4, wherein the controller is configured to generate a notification indicative of the detected sudden change or measurement above/below the second predefined threshold.

6. The controller of any preceding claim, wherein the aspirate-dispense apparatus comprises a flow meter configured to measure the monitored flow parameter of the secondary fluid, a pressure regulator configured to regulate the pressure of the secondary fluid, and a valve configured to limit the flow of primary or secondary fluid, and wherein the controller is configured to:
receive the measurement signalling for the monitored flow parameter of the secondary fluid from the flow meter to enable determination of the volume of aspirated or dispensed primary fluid; and
control the pressure regulator and valve based on the determined volume of aspirated or dispensed primary fluid to control the flow of primary or secondary fluid.

7. The controller of any preceding claim, wherein the controller is configured to generate the calibration data defining the relationship between the volume of aspirated or dispensed primary fluid and the monitored flow parameter of the secondary fluid.

8. The controller of claim 7 when dependent upon claim 6, wherein the controller is configured to generate the calibration data by:
controlling the pressure regulator and valve to aspirate or dispense one or more known volumes of primary fluid;
receiving, from the flow meter, respective measurements of the monitored flow parameter of the secondary fluid corresponding to the one or more known volumes of primary fluid; and
associating the one or more known volumes of primary fluid with the respective measurements of the monitored flow parameter of the secondary fluid.

9. The controller of claim 8, wherein the controller is configured to associate the plurality of known volumes of primary fluid with the plurality of respective measurements of the monitored flow parameter of the secondary fluid by generating one or more of a look-up table, a graph and an equation defining the relationship therebetween.

10. The controller of any of claims 7 to 9 when dependent upon claim 6, wherein the controller is further configured to control the flow of primary or secondary fluid to dispense the specific volume of primary fluid by:
controlling the pressure regulator and valve to aspirate a known volume of primary fluid;
controlling the pressure regulator and valve to incrementally dispense the aspirated primary fluid over a recorded number of dispense cycles; and
determining a cycle volume based on the known volume of primary fluid and recorded number of dispense cycles.

11. The controller of claim 10, wherein each dispense cycle has a known duration, and wherein the controller is further configured to:
determine a dispense duration required to dispense the specific volume of primary fluid based on the cycle duration and cycle volume; and
control the pressure regulator and valve to dispense the primary fluid for the determined dispense duration.

12. The controller of claim 10, wherein the controller is further configured to:
repeat the steps of claim 10 for a plurality of different cycle durations; and
associate the cycle volume with each cycle duration to generate further calibration data.

13. The controller of claim 12, wherein the controller is configured to associate the cycle volume with each cycle duration by generating one or more of a look-up table, a graph and an equation defining the relationship therebetween.

14. The controller of claim 12 or 13, wherein the controller is further configured to:
determine, using the further calibration data, the cycle duration required to dispense the specific volume of primary fluid; and
control the pressure regulator and valve to dispense the primary fluid for the determined cycle duration.

15. An aspirate-dispense apparatus comprising the controller of any preceding claim.

16. The aspirate-dispense apparatus of claim 15 when dependent upon claim 6, wherein the aspirate-dispense apparatus further comprises flow meter circuitry configured to convert an output signal from the flow meter to the received measurement signalling, and valve circuitry configured to interface the valve with the controller.

17. The aspirate-dispense apparatus of claim 15 or 16, wherein the aspirate-dispense apparatus comprises a plurality of primary fluid channels through which the primary fluid can flow into or out of the aspirate-dispense apparatus, and a plurality of corresponding secondary fluid channels connected to the respective primary fluid channels to provide the working communication between the primary and secondary fluids.

18. The aspirate-dispense apparatus of claim 17 when dependent upon claim 16, wherein each primary or secondary fluid channel comprises a filter configured to prevent the primary fluid from contacting the flow meter.

19. The aspirate-dispense apparatus of claim 17 or 18, wherein the plurality of primary fluid channels are connected to a common primary manifold configured to receive and contain the primary fluid aspirated via the plurality of primary fluid channels.

20. The aspirate-dispense apparatus of claim 17 or 18, wherein each primary fluid channel comprises a tip configured to receive and contain the primary fluid aspirated via the respective primary fluid channel.

21. The aspirate-dispense apparatus of claim 19 or 20, wherein the primary manifold or tip has a capacity which is sufficient to contain a volume of primary fluid required for multiple dispense cycles.

22. The aspirate-dispense apparatus of any of claims 17 to 21 when dependent upon claim 16, wherein the plurality of secondary fluid channels are connected to a common secondary manifold configured to interface the plurality of secondary fluid channels with the pressure regulator.

23. The aspirate-dispense apparatus of any of claims 15 to 22, wherein the primary fluid is a liquid and the secondary fluid is a gas.

24. A method of controlling one or more of aspiration and dispensing of a primary fluid by an aspirate-dispense apparatus, the aspirate-dispense apparatus comprising a secondary fluid in working communication with the primary fluid, wherein the method comprises:
receiving measurement signalling for a monitored flow parameter of the secondary fluid;
determining, using calibration data, a volume of aspirated or dispensed primary fluid based on the received measurement signalling, the calibration data defining a relationship between the volume of aspirated or dispensed primary fluid and the monitored flow parameter of the secondary fluid; and
controlling the flow of primary or secondary fluid based on the determined volume to aspirate or dispense a specific volume of primary fluid.

25. A computer program comprising computer code configured to perform the method of claim 24.
